(19) United States
(12) Patent Application Publication
(10) Pub. No.: US 2009/0296042 A1
(43) Pub. Date: Dec. 3, 2009

(54) Eyeglasses having interchangeable frames

(76) Inventor: Hsueh Chu Yeh, Tainan (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/127,038

(22) Filed: May 27, 2008

(51) Int. Cl. G02C 1/06

(52) U.S. Cl. 351/86

(57) ABSTRACT

Eyeglasses having interchangeable frames comprise an eyeglass frame mounted with at least one lens frame. The eyeglass frame is formed with at least one receiving cavity having at least one first insertion slot near a nose pad portion of the eyeglass frame, at least one through hole having a same shape as a mating lens, and at least one second insertion slot adjacent to an outward end of the through hole. When the lens frame mounted with the lens is pressed into the receiving cavity, at least one first engaging portion and at least one second engaging portion extending from the lens frame are engaged with the first and second insertion slots, respectively. Thus, the eyeglass frame is stably combined with the lens frame through a simple and rapid assembling process, allowing eyeglass manufacturers to match such eyeglass frames and lens frames of different colors as needed.

### BACKGROUND OF THE INVENTION

1. Technical Field

The present invention relates to eyeglasses having interchangeable frames, and more particularly, to eyeglasses comprising an eyeglass frame and at least one lens frame, wherein the lens frame can be stably combined with the eyeglass frame through a simple assembling process, allowing a matching of such eyeglass frames and lens frames of different colors.

2. Description of Related Art

Nowadays, the eyeglass industry offers numerous different eyeglass designs, focusing mainly on simple processing and convenient assembly, and such assembled eyeglasses can be easily seen on the market and in open publications. Common lens frames and eyeglass frames are usually put together by engaging a plurality of protrusions formed on the rear side of the lens frames with a plurality of cavities formed on the front side of the eyeglass frame. However, combination of this kind between the lens frames and the eyeglass frame tends to get loose due to a slight size difference resulting from plastic molding.

### SUMMARY OF THE INVENTION.

The present inventor aims to provide alternative eyeglasses that are assembled in the same way as the aforementioned eyeglass frame and lens frames.

It is a major objective of the present invention to provide eyeglasses having interchangeable frames, wherein the eyeglasses comprise an eyeglass frame mounted with at least one lens frame, and are characterized in that the eyeglass frame is integrally formed with at least one receiving cavity having at least one first insertion slot near a nose pad portion of the eyeglass frame, at least one through hole having a same shape as a mating lens, and at least one second insertion slot adjacent to an outward end of the through hole. When the lens frame mounted with the lens is pressed into the receiving cavity, at least one first engaging portion and at least one second engaging portion extending from the lens frame are inserted into the first and second insertion slots of the eyeglass frame, respectively. Thus, the eyeglass frame and the lens frame are stably combined through a simple and rapid assembling process, allowing eyeglass manufacturers to match such eyeglass frames and lens frames of different colors as needed.

### BRIEF DESCRIPTION OF DRAWINGS

The invention as well as a preferred mode of use, further objectives and advantages thereof will best be understood by reference to the following detailed description of illustrative embodiments when read in conjunction with the accompanying drawings, wherein:

FIG. 1 is a perspective, exploded view of eyeglasses according to a first preferred embodiment of the present invention, wherein the eyeglasses comprise an eyeglass frame engaged with two lens frames;

FIG. 2 is a perspective, assembled view of the eyeglasses according to the first preferred embodiment of the present invention, wherein the eyeglass frame is engaged with the two lens frames;

FIG. 2A is an enlarged, partial cross-sectional view of an encircled portion A in FIG. 2;

FIG. 2B is an enlarged, partial cross-sectional view of an encircled portion B in FIG. 2;

FIG. 3 is a perspective, exploded view of eyeglasses according to a second preferred embodiment of the present invention, wherein the eyeglasses comprise an eyeglass frame engaged with a single lens frame;

FIG. 4 is a perspective, assembled view of the eyeglasses according to the second preferred embodiment of the present invention, wherein the eyeglass frame is engaged with the single lens frame;

FIG. 5 is a perspective, exploded view of eyeglasses according to a third preferred embodiment of the present invention, wherein the eyeglasses comprise an eyeglass frame engaged with two lens frames;

FIG. 6 is a perspective, assembled view of the eyeglasses according to the third preferred embodiment of the present invention, wherein the eyeglass frame is engaged with the two lens frames;

FIG. 6C is an enlarged, partial cross-sectional view of an encircled portion C in FIG. 6; and

FIG. 6D is an enlarged, partial cross-sectional view of an encircled portion D in FIG. 6.

### DETAILED DESCRIPTION OF THE PREFERRED EMBODIMENTS

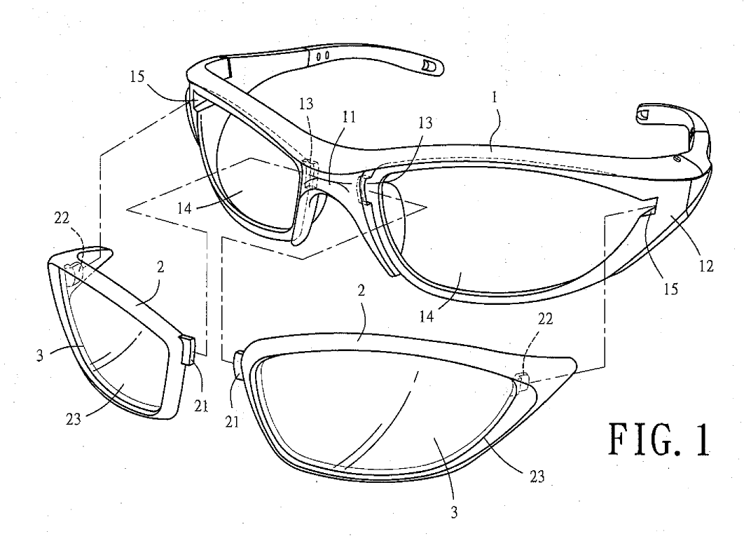

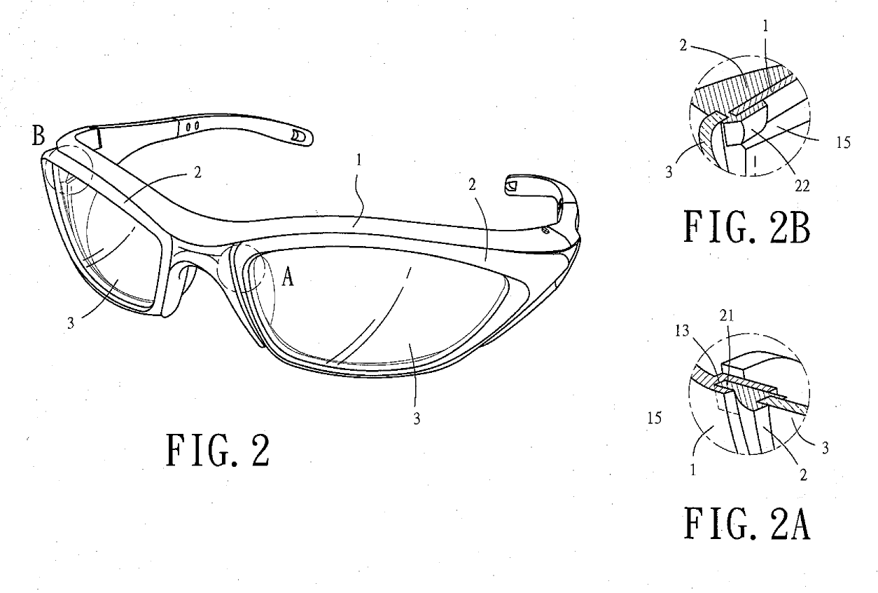

Referring to FIGS. 1 and 2, eyeglasses having interchangeable frames according to a first preferred embodiment of the present invention comprise an eyeglass frame 1, two lens frames 2, and two lenses 3.

The eyeglass frame 1 has a centrally positioned nose pad portion 11 and is formed with a receiving cavity 12 on either side of the nose pad portion 11. Each of the receiving cavities 12 is formed with a first insertion slot 13 near the nose pad portion 11, a through hole 14 having a same shape as a corresponding one of the lenses 3, and a second insertion slot 15 at an outward end of the through hole 14.

Each of the two lens frames 2 is shaped according to dimensions of a corresponding one of the receiving cavities 12 of the eyeglass frame 1 and formed with a first engaging portion 21 and a second engaging portion 22 extending therefrom and corresponding in position to the first and second insertion slots 13, 15 of the eyeglass frame 1, respectively. Each of the lens frames 2 is further formed with an engaging hole 23 for engaging with a corresponding one of the lenses 3.

To assemble the eyeglasses, the first and second engaging portions 21, 22 extending from two sides of each of the lens frames 2 are inserted into the first and second insertion slots 13, 15 of the eyeglass frame 1, respectively, as shown in FIGS. 2A and 2B, so that the lens frames 2 are snugly received in the receiving cavities 12. Thus, the eyeglass frame 1 is stably combined with the lens frames 2 through a simple and rapid assembling process, allowing eyeglass manufacturers to match such eyeglass frames 1 and lens frames 2 of different colors as desired.

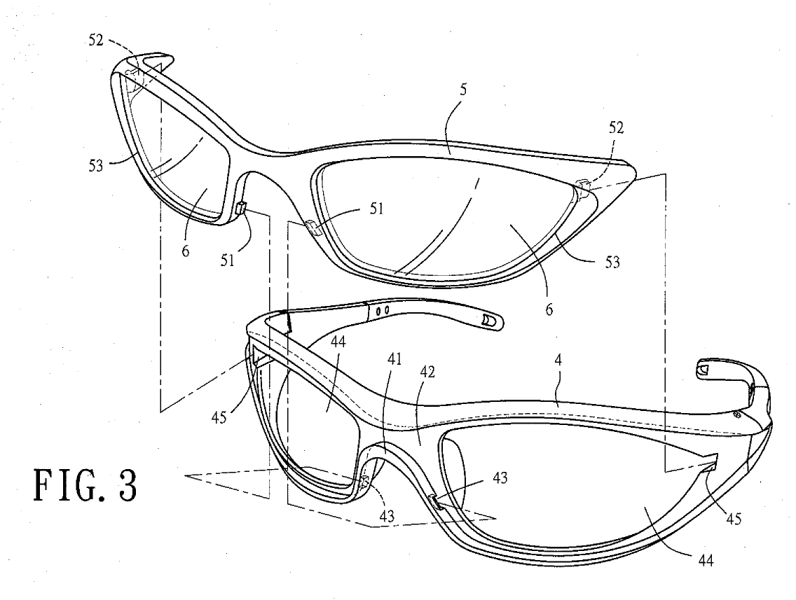

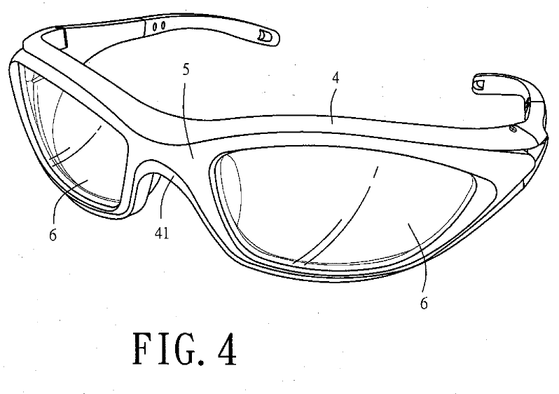

The eyeglasses having interchangeable frames of the present invention can also be realized with only one lens frame, as in a second preferred embodiment of the present invention shown in FIGS. 3 and 4, wherein the eyeglasses comprise an eyeglass frame 4, a single lens frame 5, and two lenses 6.

The eyeglass frame 4 is centrally formed with a receiving cavity 42. The receiving cavity 42 is formed with a first insertion slot 43 adjacent to either side of a nose pad portion 41 of the eyeglass frame 4, a through hole 44 on either side of the eyeglass frame 4 each having a same shape as a corresponding said lens 6, and a second insertion slot 45 at an outward end of each of the two through holes 44.

The single lens frame 5 is shaped according to dimensions of the receiving cavity 42 of the eyeglass frame 4 and formed with first engaging portions 51 and second engaging portion 52 extending therefrom and corresponding in position to the first and second insertion slots 43, 45 of the eyeglass frame 4, respectively. The lens frame 5 is further formed with engaging holes 53 for engaging with the lenses 6.

To assemble the eyeglasses of the second preferred embodiment of the present invention, the second engaging portions 52 extending from two sides of the lens frame 5 are inserted into the second insertion slots 45 of the eyeglass frame 4, respectively. Then, the first engaging portions 51 formed centrally on the lens frame 5 are inserted into the first insertion holes 43 of the eyeglass frame 4, respectively, so that the lens frame 5 is snugly received in the receiving cavity 42. Thus, the eyeglass frame 4 is stably combined with the lens frame 5 through a simple and rapid assembling process, allowing eyeglass manufacturers to match such eyeglass frames 4 and lens frames 5 of different colors as needed.

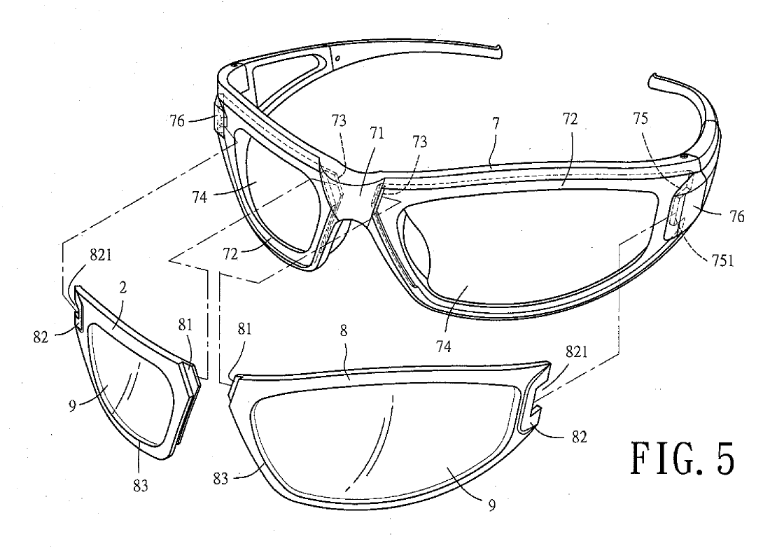

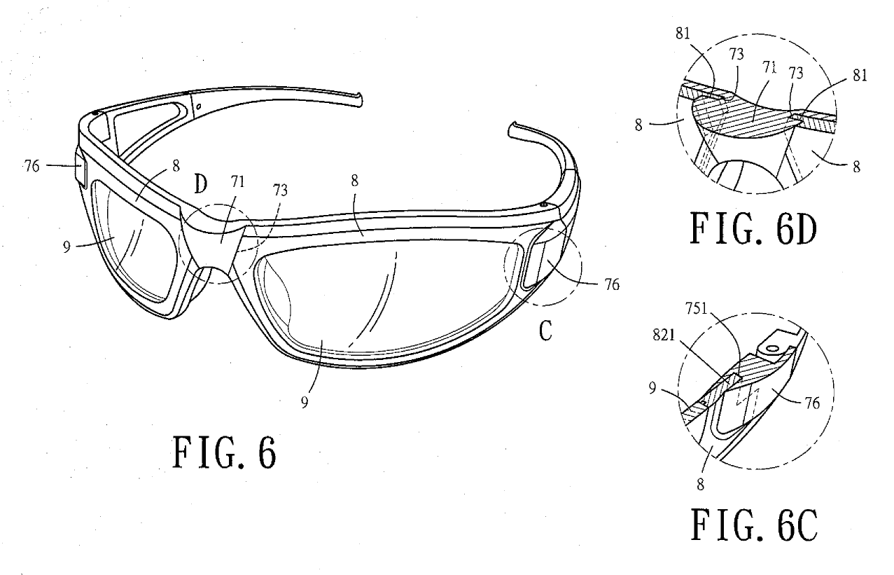

The eyeglasses having interchangeable frames of the present invention can also be realized with another two lens frames, as in a third preferred embodiment of the present invention shown in FIGS. 5 and 6, wherein the eyeglasses comprise an eyeglass frame 7, two lens frames 8 and two lenses 9.

The eyeglass frame 7 is formed with a receiving cavity 72 on either side thereof wherein each of the receiving cavities 72 is formed with a through hole 74 having a same shape as a corresponding one of the lenses 9, a first insertion slot 73 adjacent to a central nose pad portion 71 of the eyeglass frame 7, and a second insertion slot 75 which is formed with a protrusion 751 and located between each said receiving cavity 72 and a stop portion 76 provided on either side of the eyeglass frame 7.

Each of the lens frames 8 is shaped according to dimensions of a corresponding one of the receiving cavities 72 of the eyeglass frame 7 and formed with an engaging hole 83 for engaging with a corresponding one of the lenses 9. In addition, each of the lens frames 8 is formed with a first engaging portion 81 extending therefrom and corresponding in position to a corresponding one of the first insertion slots 73 of the eyeglass frame 7, and a second engaging portion 82 which has a notch 821 is formed at another end of the lens frame 8.

To assemble the eyeglasses of the third preferred embodiment of the present invention, the notches 821 on the second engaging portions 82 of the two lens frames 8 are engaged with the protrusions 751 of the second insertion slots 75 of the eyeglass frame 7, respectively, as shown in FIG. 6C. Then, the first engaging portions 81 of the lens frames 8 are inserted into the first insertion slots 73 of the eyeglass frame 7, respectively, as shown in FIG. 6D, so that the lens frames 8 are received snugly in the receiving cavities 72. Thus, the eyeglass frame 7 is stably combined with the lens frames 8 through a simple and rapid assembling process, allowing eyeglass manufacturers to match such eyeglass frames 7 and lens frames 8 of different colors as needed.

The present invention has been described with preferred embodiments thereof, which are provided for illustrative purposes only and not intended to limit the scope of the present invention. Moreover, as the content disclosed herein should be readily understood and can be implemented by a person skilled in the art, all equivalent changes or modifications which do not depart from the spirit of the present invention are encompassed by the appended claims.

What is claimed is:

1. Eyeglasses having interchangeable frames, comprising an eyeglass frame mounted with at least one lens frame, said eyeglasses being characterized in that:
said eyeglass frame is integrally formed with at least one receiving cavity, wherein said receiving cavity has at least one first insertion slot near a nose pad portion of said eyeglass frame, at least one through hole having a same shape as a mating lens, and at least one second insertion slot adjacent to an outward end of said through hole, so that when said lens frame mounted with the mating lens is pressed into said receiving cavity, at least one first engaging portion and at least one second engaging portion extending from said lens frame are inserted into said first and second insertion slots of said eyeglass frame, respectively, whereby said eyeglass frame and said lens frame are stably combined through a simple and rapid assembling process, allowing eyeglass manufacturers to match such eyeglass frames and lens frames of different colors as needed.

2. The eyeglasses as claimed in claim 1, wherein said eyeglass frame is mounted with two said lens frames.

3. The eyeglasses as claimed in claim 1, wherein said eyeglass frame is mounted with one said lens frame.

4. The eyeglasses as claimed in claim 1, wherein said eyeglass frame to be mounted with said lens frame is bilaterally formed with stop portions at corresponding positions, in which said second insertion slot is formed with a protrusion and located between said receiving cavity and a corresponding one of said stop portions, and said second engaging portion of the lens frame has a recess to be engaged with said protrusion of said second insertion slot.

5. The eyeglasses as claimed in claim 4, wherein said eyeglass frame is mounted with two said lens frames.

6. The eyeglasses as claimed in claim 4, wherein the eyeglass frame is mounted with one said lens frame.
